(19) United States
(12) Patent Application Publication
(10) Pub. No.: US 2016/0315438 A1
(43) Pub. Date: Oct. 27, 2016

(54) TERMINAL FEEDING DEVICE

(71) Applicant: SUMITOMO WIRING SYSTEMS, LTD., Mie (JP)

(72) Inventor: Makoto HATTORI, Mie (JP)

(73) Assignee: SUMITOMO WIRING SYSTEMS, LTD., Mie (JP)

(21) Appl. No.: 15/104,811

(22) PCT Filed: Dec. 10, 2014
(86) PCT No.: PCT/JP2014/082700

§ 371 Date: Jun. 15, 2016

(30) Foreign Application Priority Data
Dec. 25, 2013 (JP) 2013-266397

(51) Int. Cl. H01R 43/055

(52) U.S. Cl. CPC H01R 43/055

(57) ABSTRACT

A terminal feeding device for feeding a series of terminals in which a plurality of terminals are continuously arranged, one terminal after another, includes: a stage on which the series of terminals can be placed; a feeding pawl that is arranged to move back and forth in a feeding direction and a returning direction that is opposite to the feeding direction, the feeding pawl latching, when moving in the feeding direction, with its leading end portion to a feeding hole of the series of terminals on the stage, and feeding the series of terminals in the feeding direction; a pawl moving mechanism portion for moving the feeding pawl back and forth; and a moving distance restriction portion for restricting a distance by which the feeding pawl is moved by the pawl moving mechanism portion, wherein the moving distance restriction portion is attachable and detachable.

### TECHNICAL FIELD

This invention relates to techniques for feeding a series of terminals formed by a plurality of continuously arranged terminals, one terminal after another.

### BACKGROUND ART

A terminal feeding device (terminal crimping applicator) for continuously crimping terminals to end portions of wires or the like may be configured to include a terminal feeding device for letting out an elongated series of terminals, which is wound in a reel-like manner, and sequentially feeding this series of terminals, one terminal after another, along a predetermined feeding path, and a crimping device for swaging the terminal at the front of the terminals that have been fed to a predetermined position using a mold and crimping this terminal to a wire. These devices operate in conjunction with each other to continuously perform a crimping process (e.g., see Patent Document 1).

As described in Patent Document 1, conventionally, a configuration has been used in general in which a pawl-shaped member (feeding pawl) latches to a feeding hole formed in the series of terminals, and this feeding pawl is moved in a feeding direction by the pitch of the terminals, thereby feeding the series of terminals, one terminal after another.

### CITATION LIST

### Patent Documents

Patent Document 1: JP 2008-153056A

### SUMMARY OF INVENTION

### Technical Problem

In general, the pitch of the terminals continuously arranged in a series of terminals depends on the type or the like of the terminals. Accordingly, to deal with different kinds of series of terminals, the feeding amount per one feeding (in a conventional terminal feeding device, specifically, the amount of movement of the feeding pawl) needs to be changed in accordance with the pitch of the terminals in the series of terminals to be fed out.

However, to change the amount of movement of the feeding pawl, mechanical adjustment needs to be performed, which takes a lot of effort. Accordingly, in many cases, one type of series of terminals is associated with one terminal feeding device, and if the series of terminals to be fed out is changed, the terminal feeding device is replaced with one that corresponds to the new series of terminals and is then used. This configuration cannot quickly deal with the change of the series of terminals, and a large number of terminal feeding devices need to be prepared, which is disadvantageous in terms of costs.

This invention has been made in view of the foregoing problem, and an object of the invention is to provide a technique with which different types of series of terminals can be flexibly dealt with.

### Solution to Problem

In order to solve the foregoing problem, a terminal feeding device according to a first aspect is A terminal feeding device for feeding a series of terminals in which a plurality of terminals are continuously arranged, one terminal after another, including: a stage on which the series of terminals can be placed; a feeding pawl that is arranged to move back and forth in a feeding direction and a returning direction that is opposite to the feeding direction, the feeding pawl latching, when moving in the feeding direction, with its leading end portion to a feeding hole of the series of terminals on the stage, and feeding the series of terminals in the feeding direction; a pawl moving mechanism portion for moving the feeding pawl back and forth; and a moving distance restriction portion for restricting a distance by which the feeding pawl is moved by the pawl moving mechanism portion, wherein the moving distance restriction portion is attachable and detachable, a restriction distance of the moving distance restriction portion that has been removed can be adjusted, or the moving distance restriction portion that has been removed can be replaced with a moving distance restriction portion having a different restriction distance, and the distance by which the feeding pawl is moved by the pawl moving mechanism portion can be changed.

A terminal feeding device according to a second aspect is the terminal feeding device according to the first aspect further including: a support mechanism portion for supporting the pawl moving mechanism portion so as to be able to move back and forth between a first position and a second position; and a pawl biasing member for biasing the feeding pawl toward the first position, wherein the pawl moving mechanism portion pushes the feeding pawl from the first position to the second position, and the moving distance restriction portion includes a contacted portion for restricting the movement of the feeding pawl while the feeding pawl is moving from the first position to the second position and/or while the feeding pawl is moving from the second position to the first position.

A terminal feeding device according to a third aspect is the terminal feeding device according to the first or second aspect further including: a reel supporting portion for rotatably supporting a terminal reel around which the series of terminals is wound; a terminal guiding mechanism portion including a shaft portion that is rotatable, an arm portion extending from the shaft portion, and a guiding portion provided at a leading end of the arm portion, the terminal guiding mechanism portion being provided so as to be able to guide at least a part of the series of terminals wound around the terminal reel to the stage; and a guiding and biasing member capable of biasing the terminal guiding mechanism portion, wherein the terminal guiding mechanism portion changes a posture thereof or rotates in accordance with a direction in which the series of terminals is supplied from the terminal reel.

### Advantageous Effects of Invention

With the terminal feeding devices according to the first to third aspects, the moving distance restriction portion is provided in an attachable and detachable manner, and the moving distance of the feeding pawl moved by the pawl moving mechanism portion can be changed by adjusting the restriction distance of the moving distance restriction portion or replacing the moving distance restriction portion with one having a different restriction distance. Therefore, multiple types of terminals can be flexibly dealt with.

In particular, with the terminal feeding device according to the third aspect, the direction of supplying the series of terminals may change when the terminal reel is connected in the opposite orientation. Due to the provision of the terminal guiding mechanism portion provided so as to be able to guide at least a part of the series of terminals wound around the terminal reel until reaching the stage, and the biasing member capable of biasing the terminal guiding mechanism portion, the case where the terminal reel is connected in the opposite orientation can also be dealt with. Thus, multiple types of terminals can be flexibly dealt with.

### BRIEF DESCRIPTION OF DRAWINGS

FIG. 1 is an illustrative diagram showing a cut-and-crimp setting device.

FIG. 2 is a plan view showing a series of terminals.

FIG. 3 is an illustrative diagram showing a terminal crimping system.

FIG. 4 is an illustrative diagram showing a terminal feeding device according to an embodiment.

FIG. 5 is an illustrative diagram showing the terminal feeding device at the time when the series of terminals is wound in an opposite manner.

FIG. 6 is a schematic plan view showing a terminal feeding mechanism portion.

FIG. 7 is a schematic bottom view showing the terminal feeding mechanism portion.

FIG. 8 is a schematic side view showing the terminal feeding mechanism portion.

FIG. 9 is a front view showing a moving distance restriction portion.

FIG. 10 is a plan view showing the moving distance restriction portion.

FIG. 11 is an illustrative diagram showing a part of the terminal feeding mechanism portion.

FIG. 12 is an illustrative diagram showing a part of the terminal feeding mechanism portion.

FIG. 13 is an illustrative diagram showing a part of the terminal feeding mechanism portion.

### DESCRIPTION OF EMBODIMENTS

Hereinafter, a terminal feeding device according to an embodiment will be described. Here, the terminal feeding device according to the embodiment is incorporated in a terminal crimping system 25 of a cut-and-crimp setting device 1.

### 1. Cut-and-Crimp Setting Device

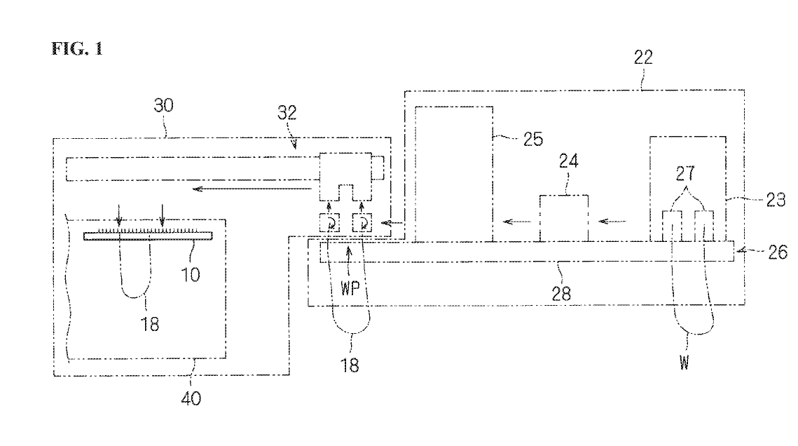

First, an overall configuration of the cut-and-crimp setting device 1 will be described. FIG. 1 is an illustrative diagram showing the overall configuration of the cut-and-crimp setting device 1. This cut-and-crimp setting device 1 is for processing, using the wire end portion setting mechanism portion 30, a wire 18 with terminals that has been processed by a cut-and-crimp mechanism portion 22. The cut-and-crimp setting device 1 is configured such that the long length of the wire is cut off and terminals are crimped thereto by the aforementioned cut-and-crimp mechanism portion 22, and, in the wire end ^{portion} setting mechanism portion 30, end portions of this wire 18 with terminals are sequentially set onto the a wire holding bar 10, so that the wire 18 with terminals can be taken to the outside together with the wire holding bar 10.

The cut-and-crimp mechanism portion 22 is configured to be able to cut off a wire and crimp terminals to end portions of the wire. Here, the cut-and-crimp mechanism portion 22 is configured to be able to manufacture multiple types of wires 18 with terminals in a predetermined order, and the wires 18 with terminals can be manufactured in the order in which multiple types of wires 18 with terminals are mixed as appropriate, or the same type of wires 18 with terminals can also be continuously manufactured.

More specifically, the cut-and-crimp mechanism portion 22 includes a wire length adjusting and cutting portion 23, a wire stripping portion 24, and a terminal crimping system 25, and also has a wire end portion conveying mechanism portion 26 for conveying wire end portions.

The wire length adjusting and cutting portion 23 is configured to be able to selectively cut multiple types of wires to a predetermined length, and can employ, for example, a configuration having a reel, around which a wire is wound and housed, a wire length measuring and drawing portion for drawing the wire from the reel while measuring the wire length, a wire cutting portion for cutting off the drawn wire, and a folding-back portion for folding back the drawn wire in a U-shape. The wire is drawn from the reel by the predetermined length by the driving of the wire length measuring and drawing portion, and the wire is cut off with the wire cutting portion. An end portion of the drawn wire is folded back by the folding-back portion into a substantial U-shape, and both end portions thereof are set onto the aforementioned wire end portion conveying mechanism portion 26. A wire W that has been cut out into the predetermined length is thereby obtained. Moreover, a wire selecting and supplying portion in which a plurality of aforementioned reels are provided and that enables a wire to be selectively supplied from each reel is provided. This portion enables multiple types of wires to be switched as appropriate and cut into the predetermined length.

As a configuration of the wire length adjusting and cutting portion 23 for thus selectively supplying multiple types of wires and cutting the wires into the predetermined length, for example, a well-known configuration disclosed in JP 9-306257A or the like can be employed.

The wire stripping portion 24 is for stripping end portions of the wire W, and may employ a configuration having a pair of stripping blades that can be brought close to and separated from each other, and a back-and-forth driving portion for pointing the stripping blades to the end portions of the wire W and driving the stripping blades back and forth, for example. Covering portions of the end portions of the wire W are stripped off by moving the pair of stripping blades so as to bring the stripping blades close to the end portions of the wire that has been conveyed to this wire stripping portion 24, and moving the pair of stripping blades toward the end portions of the wire in a state where the stripping blades are caused to cut into the covering portions of the wire W. As such a wire stripping portion 24, various well-known configurations can be employed, such as a configuration in which a covering portion is removed with a pair of stripping blades as mentioned above.

The terminal crimping system 25 is configured to be able to selectively crimp multiple types of terminals to end portions of the wire W, and for example, a crimping device can be used that has multiple pairs of die sets and in which one of the multiple pairs of die sets can be set at a common terminal crimping position, the crimping terminal being configured to be able to selectively supply the multiple types of terminals to the aforementioned terminal crimping position.

Upon the end portions of the wire W that have been stripped off by the aforementioned wire stripping portion 24 being conveyed to this terminal crimping system 25, predetermined terminals, which are set in advance, are selected and supplied, and a pair of die sets that corresponds to the predetermined terminals is selected and set at the terminal crimping position. Thus, the predetermined terminals are crimped to the end portions of the wire W, and the wire 18 with terminals is obtained. Note that the terminal crimping system 25 will be described later.

The wire end portion conveying mechanism portion 26 is configured to be able to hold the end portions of the wire W and convey them from the wire length adjusting and cutting portion 23 to a delivery position WP on the wire end portion setting mechanism portion 30 side via the wire stripping portion 24 and the terminal crimping system 25. More specifically, the wire end portion conveying mechanism portion 26 has a pair of wire end portion holding portions 27 capable of holding and releasing both end portions of the wire W, and a wire end portion back-and-forth driving portion 28 for moving this wire end portion holding portions 27 back and forth between the delivery position WP and each of the positions corresponding to the wire length adjusting and cutting portion 23, the wire stripping portion 24, and the terminal crimping system 25.

The wire end portion holding portions 27 each have a pair of holding pieces that can open and close. An end portion of the pair of holding pieces is supported so as to be able to rotate around a predetermined axis, and the posture of the pair of holding pieces can be changed between a close posture of being closed in an erected manner and an open posture of being open in a lodged manner by being driven by an actuator such as an air cylinder, or the like. This pair of wire end portion holding portions 27 is movably provided in a state in which it is separate from the wire end portion back-and-forth driving portion 28 at a predetermined interval.

The wire end portion back-and-forth driving portion 28 has an actuator such as a linear motor, and is configured to move the aforementioned pair of wire end portion holding portions 27 toward the delivery position WP from the wire length adjusting and cutting portion 23 via the wire stripping portion 24 and the terminal crimping system 25. The wire end portion back-and-forth driving portion 28 temporarily stops when the end portions of the wire W held by the wire end portion holding portions 27 pass through operation positions in the wire stripping portion 24 and the terminal crimping system 25, and causes a stripping process, a terminal crimping process, and the like to be performed on the end portions of the wire W. Then, the end portions of the wire 18 with terminals that has been cut into the predetermined length, whose end portions have been stripped, and to which the terminals have been crimped, are conveyed to the delivery position WP that is set at a position closer to the wire end portion setting mechanism portion 30 than to the aforementioned terminal crimping system 25, and here, these end portions are configured to be delivered to the wire end portion setting mechanism portion 30.

Note that, although the cut-and-crimp mechanism portion 22 in this embodiment is configured such that both the type of wires and the type of terminals can be changed, it is also possible that only either one of them can be changed. The cut-and-crimp mechanism portion 22 may also be configured to continuously crimp one type of terminals to the end portions of one type of wires.

The wire end portion setting mechanism portion 30 includes a wire end portion holding and setting portion 32, and a wire holding bar supporting portion 40.

The wire end portion holding and setting portion 32 is configured to be able to hold the end portions of the wire 18 with terminals to which the terminals have been crimped by the cut-and-crimp mechanism portion 22, and sequentially set the end portions of the wire 18 with terminals to respective wire holding portions 14 of the wire holding bar 10, which is supported by the wire holding bar supporting portion 40.

As a configuration of the wire end portion setting mechanism portion 30 itself for thus setting the end portions of the wire 18 with terminals to the wire holding bar 10 supported by the wire holding bar supporting portion 40, for example, a well-known configuration disclosed in JP 2009-152104A may be employed.

### 2. Series of Terminals 9

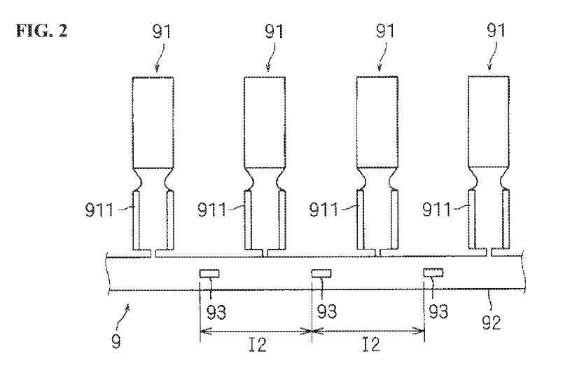

Here, the series of terminals 9 will be described. FIG. 2 is a plan view showing the series of terminals 9.

The series of terminals 9 is a band-shaped member in which a plurality of terminals 91 are continuously arranged. Specifically, the series of terminals 9 is formed by the plurality of terminals 91 being linked up in parallel at equal intervals on one side of a band-shaped chain band 92. In the chain band 92, feeding holes 93 are formed at equal intervals so as to correspond to the respective terminals 91. A base portion (barrel portion) 911 of each terminal 91 is formed to be opened with a substantially U-shaped cross section so that it can be crimped to an end portion of a wire.

As will become clear later, as a result of the chain band 92 being cut into a length corresponding to one terminal 91 (specifically, as a result of the chain band 92 being cut off at a roughly middle position between a terminal 91 at an end portion of the series of terminals 9 and an adjacent terminal 91), the terminal 91 at the end portion of the series of terminals 9 is cut off from the series of terminals 9 in a state in which it is connected to a band piece 921, which is a chain band 92 that has been cut out, having a length corresponding to the one terminal 91. This terminal 91 with the band piece 921 will also be hereinafter called a “terminal 90 with the band piece”.

### 3. Terminal Crimping System

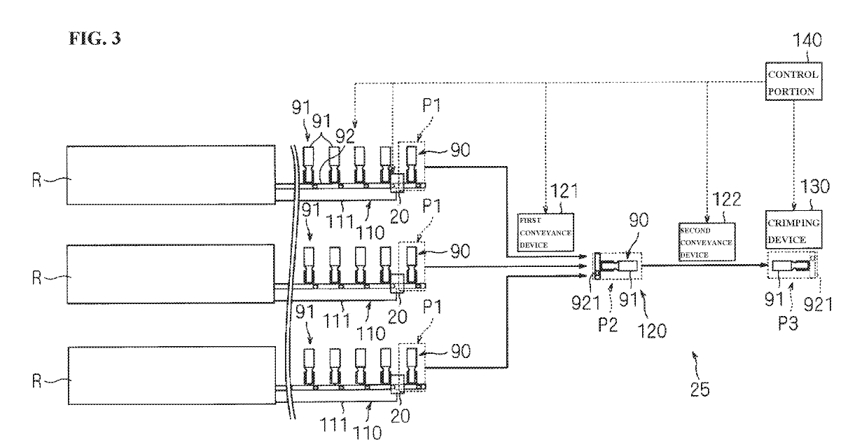

Next, a configuration of the terminal crimping system 25 will be described with reference to FIG. 3. FIG. 3 is a diagram schematically showing a configuration of the terminal crimping system 25.

The terminal crimping system 25 includes a plurality of (in the shown example, three) terminal feeding devices 110, a terminal conveyance system 120, a crimping device 130, and a control portion 140.

### Terminal Feeding Device 110

The terminal feeding devices 110 each feed the series of terminals 9, one terminal 91 after another, toward a starting position P1. The terminal feeding devices 110 will be described later in detail.

### Terminal Conveyance System 120

The terminal conveyance system 120 sequentially conveys the terminal 91 that has been fed to the starting position P1 of each of the plurality of terminal feeding devices 110 to a given target position P3. Specifically, the terminal conveyance system 120 primarily includes cutting devices 20, which are provided at respective starting positions P1, and two conveyance devices, namely a first conveyance device 121 and a second conveyance device 122, which are provided between the starting positions P1 and the target position P3.

The cutting devices 20 each cut the chain band 92 of the series of terminals 9 into the length corresponding to one terminal 91 (more specifically, cuts the chain band 92 at a middle position between the terminal 91 that has been fed to the starting position P1 and an adjacent terminal 91), and cuts out one terminal 90 together with the band piece from the series of terminals 9. Specifically, the cutting device 20 is configured to include a cutter, a driving mechanism for moving the cutter in a direction of approaching and moving away from the chain band 92, and the like, for example.

The first conveyance device 121 and the second conveyance device 122 convey the terminal 91 (specifically, the terminal 90 with the band piece) while delivering it from the respective starting position P1 to the target position P3. That is to say, a delivery position P2 is provided between the starting positions P1 and the target position P3. The first conveyance device 121 conveys the tₑᵣminal 90 with the band piece from the starting position P1 to the delivery position P2, and the second conveyance device 122 receives the terminal 90 with the band piece from the first conveyance device 121 at the delivery position P2 and conveys this terminal 90 with the band piece to the target position P3.

### Crimping Device 130

The crimping device 130 cuts off, at the target position P3, the band piece 921 of the terminal 90 with the band piece that has been fed here from the terminal 91, and swages the barrel portion 911 of the terminal 91 that has been cut off from the band piece 921 using a mold, thereby crimping and fixing this barrel portion 911 to an end portion of the wire. The terminal 91 is thereby fixed to the end portion of the wire, and a wire with terminals is manufactured. The crimping device 130 specifically is configured to include a cutter for cutting off the band piece 921 from the terminal 90 with the band piece, an upper mold for crimping, a lower mold for crimping that is arranged so as to oppose the upper mold, a driving mechanism for moving the upper mold and the lower mold in a direction of approaching and moving away from each other, and the like, for example.

### Control Portion 140

The control portion 140 is electrically connected to the plurality of terminal feeding devices 110, the terminal conveyance system 120, and the crimping device 130, and controls these portions 110, 120, and 130. Specifically, for example, the control portion 140 is constituted by a general computer in which a CPU for performing various kinds of arithmetic processing, a ROM for storing programs or the like, a RAM that serves as a work area for arithmetic processing, a hard disk for storing programs, various data files, or the like, a data communication portion having a function of communicating data via, for example, a LAN, and the like are connected to one another by a bus line or the like. The control portion 140 is connected to a display for performing various kinds of display, and an input portion constituted by a keyboard, a mouse, or the like, for example.

### 4. Terminal Feeding Device 110

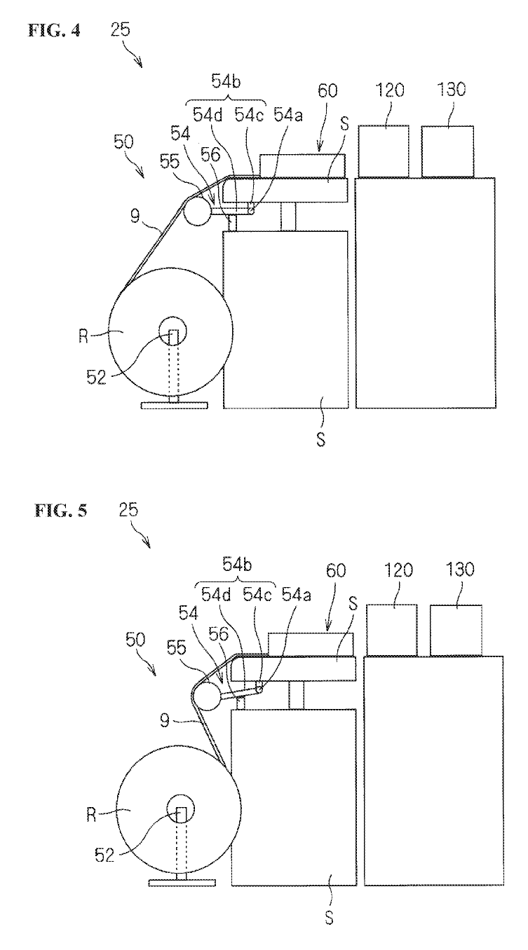

Next, the terminal feeding device 110 will be described. FIG. 4 is an illustrative diagram showing the terminal feeding device 110 according to this embodiment.

Here, the terminal feeding device 110 includes a terminal supply portion 50 and a terminal feeding mechanism portion 60.

### Terminal Supply Portion 50

The terminal supply portion 50 includes a reel supporting portion 52, a terminal guiding mechanism portion 54, and a guiding and biasing member 56.

The reel supporting portion 52 is provided so as to rotatably support a terminal reel R, around which the series of terminals 9 is wound.

The terminal guiding mechanism portion 54 is able to guide at least a part of the series of terminals 9 wound around the terminal reel R until reaching a stage 111 of the terminal feeding mechanism portion 60. The terminal guiding mechanism portion 54 is provided so as to be able to change the posture thereof or rotate in accordance with the direction of supplying the series of terminals 9 from the terminal reel R. Specifically, the terminal guiding mechanism portion 54 includes a shaft portion 54a, arm portions 54b, and a guiding portion 55.

The shaft portion 54a is rotatably provided. The arm portions 54b are formed so as to extend from the shaft portion 54a. Specifically, here, the arm portions 54b extend in two directions from the shaft portion 54a. One of the arm portions 54b, namely an arm portion 54c is continuous with a workbench S, while the other of the arm portions 54b, namely an arm portion 54d is formed such that the guiding portion 55 is continuous therewith. One arm portion 54c and the other arm portion 54d are connected by the shaft portion 54a so as to be able to rotate relative to each other.

The guiding portion 55 is provided at a leading end of the other arm portion 54d. Here, the guiding portion 55 is formed in a circular column shape such that the series of terminals 9 moves on a side surface thereof. That is to say, the guiding portion 55 can curve the supply path of the series of terminals 9 until the series of terminals 9 reaches the terminal feeding mechanism portion 60 from the terminal reel R.

The guiding and biasing member 56 is provided so as to be able to bias the terminal guiding mechanism portion 54. Specifically, here, the guiding and biasing member 56 is provided on the workbench S so as to bias the other arm portion 54d upward.

The terminal guiding mechanism portion 54 and the guiding and biasing member 56 are provided so as to be able to guide the series of terminals 9 to the stage 111 regardless of how the series of terminals 9 is wound.

Here, a description will be given of how the series of terminals 9 is fed from the terminal reel R to the stage 111 in accordance with the way the series of terminals 9 is wound. FIG. 5 is an illustrative diagram showing the terminal feeding device 110 at the time when the series of terminals 9 is wound in a direction opposite to that in FIG. 4.

In the terminal feeding device 110 according to the embodiment, the series of terminals 9 is fed from the terminal supply portion 50 to the terminal feeding mechanism portion 60 such that the barrel portion 911, which is swaged when being crimped to the wire W, faces upward. In FIG. 4, the series of terminals 9 is wound around the terminal reel R such that the barrel portions 911 (an opening portion of the barrel portions 911) face outward (hereinafter referred to as “outward winding”). However, depending on the series of terminals 9, there are also cases where the series of terminals 9 is wound around the terminal reel R such that the barrel portions 911 (the opening portion of the barrel portions 911) face inward, as shown in FIG. 5 (hereinafter referred to as “inward winding”). In this case, the direction in which the series of terminals 9 are supplied is different from that in FIG. 4. Thus, the terminal guiding mechanism portion 54 and the guiding and biasing member 56 are parts that enable one terminal feeding device 110 to deal with cases where the terminal supplying direction is different depending on whether the winding manner of the series of terminals 9 is inward winding or outward winding.

Specifically, here, the terminal reel R is arranged below the terminal feeding mechanism portion 60 at a position near the terminal feeding mechanism portion 60. At this time, there is a position on the supply path at which the series of terminals 9 bends (hereinafter referred to as a bending position) occurs. Note that the closer the position of the terminal reel R is arranged at a position immediately below the terminal feeding mechanism portion 60, the more the overall equipment can be made compact.

However, the closer the terminal reel R is arranged at a position immediately below the terminal feeding mechanism portion 60, the smaller the bending angle at the bending position on the supply path from the terminal reel R to the terminal feeding mechanism portion 60 is. Furthermore, in the case of this embodiment, the bending angle of the supply path from the terminal reel R to the terminal feeding mechanism portion 60 is smaller in the case of inward winding than in the case of outward winding.

If the bending angle of the supply path from the terminal reel R to the terminal feeding mechanism portion 60 is this small, the series of terminals 9 may be broken or cracked in some cases. The terminal guiding mechanism portion 54 and the guiding and biasing member 56 are configured so as to be able to bring the bending angle of the supply path from the terminal reel R to the terminal feeding mechanism portion 60 close to 180 degrees (i.e., close to a horizontal state).

That is to say, if the terminal guiding mechanism portion 54 is not provided, the bending position on the supply path from the terminal reel R to the terminal feeding mechanism portion 60 is a position at which the series of terminals 9 is caused to be horizontal on the workbench S (or the stage 111). The guiding portion 55 of the terminal guiding mechanism portion 54 projects outward from an outer peripheral portion of the workbench S, thereby being provided on the side opposite to the side where the terminal feeding mechanism portion 60 is present relative to the bending position in the horizontal direction. Thus, the bending angle of the series of terminals 9 at this bending position can be increased. That is to say, as a result of the terminal guiding mechanism portion 54 being provided, the series of terminals 9 can be smoothly curved on the guiding portion 55 at a position that is further separate from the terminal feeding mechanism portion 60 than the bending position is in the horizontal direction, and the bending angle at the bending position can thereby be increased.

In particular, in the case of inward winding as shown in FIG. 5, if the guiding portion 55 is not provided so as to be able to rotate or change the posture thereof, there is a concern that the angle at which the feeding directions of the series of terminals 9 before and after the curve at the guiding portion 55 are connected is too small. However, as a result of the guiding portion 55 being provided so as to be able to rotate or change the posture thereof, in the case where the angle at which the feeding directions of the series of terminals 9 before and after the curve are connected is small, the angle at which the feeding directions of the series of terminals 9 before and after the curve are connected can be increased by the guiding portion 55 rotating around the shaft portion 54a against the biasing force of the guiding and biasing member 56.

Note that, although an example where the guiding portion 55 rotates around the shaft portion 54a has been described here, the guiding portion 55 may be able to change the posture thereof by lowering, for example, as a result of the arm portion 54b being coupled to the guiding and biasing member 56, for example.

### Terminal Feeding Mechanism Portion 60

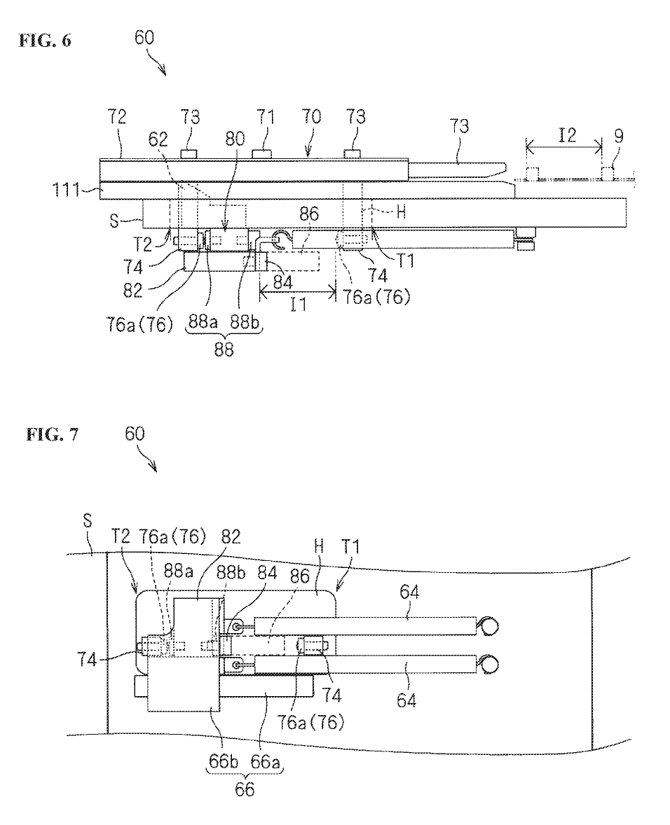

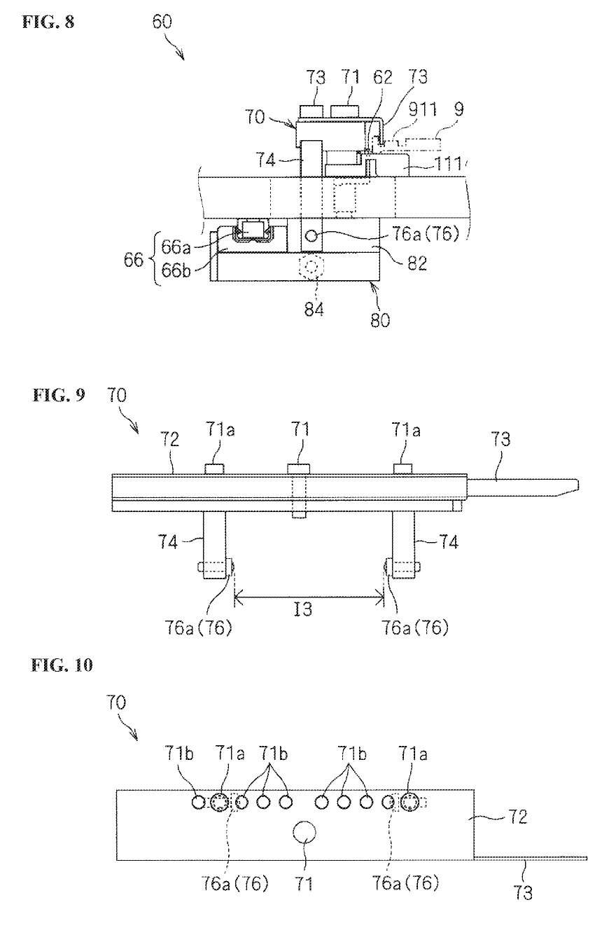

Next, the terminal feeding mechanism portion 60 will be described. FIG. 6 is a schematic front view showing the terminal feeding mechanism portion 60. FIG. 7 is a schematic bottom view showing the terminal feeding mechanism portion 60. FIG. 8 is a schematic side view showing the terminal feeding mechanism portion 60. FIG. 9 is a front view showing a moving distance restriction portion 70. FIG. 10 is a plan view showing the moving distance restriction portion 70.

The terminal feeding mechanism portion 60 includes the stage 111, a feeding pawl 62, a pawl moving mechanism portion 80, and the moving distance restriction portion 70. Furthermore, here, the terminal feeding mechanism portion 60 includes a pawl biasing member 64, and a support mechanism portion 66. The terminal feeding mechanism portion 60 is installed on the workbench S. The workbench S is provided with a hole H, and the feeding pawl 62 is provided so as to be able to move within this hole H. Here, a part of an inner peripheral portion of the hole H that is located in a returning direction of the feeding pawl 62 will be referred to as a first position T1, and a part thereof located in an advancing direction of the feeding pawl 62 will be referred to as a second position T2. However, the first position T1 and the second position T2 are not limited to the aforementioned positions. The first position T1 and the second position T2 are positions that can be suitably set as long as these positions are two different locations at which a later-described driving mechanism can press a coupling portion along the feeding direction.

The stage 111 is formed such that the series of terminals 9 can be placed thereon. Specifically, the stage 111 is formed in an elongated plate shape, and here, the stage 111 is fixed onto the workbench S. The stage 111 is provided with a hole that a leading end portion of the feeding pawl 62 can enter.

The support mechanism portion 66 supports the pawl moving mechanism portion 80 so that it can move back and forth between the first position T1 and the second position T2. The support mechanism portion 66 includes a linear movement guiding portion 66a and a moving body portion 66b. Specifically, the linear movement guiding portion 66a is formed in a straight bar shape, and is fixed to a lower portion of the workbench S. The moving body portion 66b is movably supported by the linear movement guiding portion 66a, and can linearly move back and forth along the linear movement guiding portion 66a.

The pawl moving mechanism portion 80 is provided at a lower portion of the workbench S. The pawl moving mechanism portion 80 includes a coupling portion 82, a pressed portion 84, a driving mechanism 86, and contact portions 88. Specifically, the coupling portion 82 is coupled to the moving body portion 66b of the support mechanism portion 66, and as a result of the moving body portion 66b moving along the linear movement guiding portion 66a, the pawl moving mechanism portion 80 can also linearly move back and forth between the first position T1 and the second position T2.

The pressed portion 84 is a part that comes into contact with the driving mechanism 86 and is pressed by the driving mechanism 86. Here, the pressed portion 84 is provided in a side surface of a lower portion of the coupling portion 82. The pressed portion 84 is pressed in the feeding direction by the driving mechanism 86. Thus, the moving body portion 66b coupled to the coupling portion 82 can be moved in the feeding direction by the driving mechanism 86 against the biasing force of the guiding and biasing member 56. Upon the pressing by the driving mechanism 86 being cancelled, the moving body portion 66b is moved in the returning direction by the biasing force of the pawl biasing member 64.

The contact portions 88 are provided in the coupling portion 82, and are provided so that it can come into contact with the moving distance restriction portion 70. The contact portions 88 include a feeding-direction contact portion 88a that comes into contact with the moving distance restriction portion 70 when moving in the feeding direction, and a returning-direction contact portion 88b that comes into contact with the moving distance restriction portion 70 when moving in the returning direction. As a result of the contact portions 88 coming into contact with the moving distance restriction portion 70, the coupling portion 82 stops, and the feeding pawl 62 also stops.

The driving mechanism 86 can move the feeding pawl 62. Specifically, the driving mechanism 86 is constituted by an actuator such as an air cylinder, and is provided so as to be able to press the pressed portion 84 of the coupling portion 82 in one direction (here, the feeding direction).

The driving mechanism 86 is provided so as to be able to press the pressed portion 84 of the pawl moving mechanism portion 80 from the first position T1 toward the second position T2. Here, the first position T1 and the second position T2 are set respectively to a position before the feeding (returning position) and a position after the feeding (feeding position). Thus, here, the direction extending from the first position T1 to the second position T2 is the feeding direction, and the direction extending from the second position T2 to the first position T1 is the returning direction. However, a configuration may also be employed in which the first position T1 is set to a position after the feeding (feeding position), the second position T2 is set to a position before the feeding (returning position), the direction extending from the first position T1 to the second position T2 is the returning direction, and the direction extending from the second position T2 to the first position T1 is the feeding direction.

The pawl biasing member 64 is a member for coupling the coupling portion 82 to the workbench S and biasing the coupling portion 82 to one side (here, in the returning direction). Here, the pawl biasing member 64 is provided so as to be able to bias the coupling portion 82 from the second position T2 toward the first position T1. Although the pawl biasing member 64 is constituted by tension coil springs 64a or the like here, the pawl biasing member 64 need only be able to bias the coupling portion 82 to one side. Although two tension coil springs are provided as the pawl biasing member 64 here, the number of tension coil springs 64a may also be one, or may also be three or more. However, as a result of the tension coil springs 64a used as the pawl biasing member 64 being symmetrically provided so as to sandwich the pressed portion 84 as shown in FIG. 7, generation of a moment in the coupling portion 82 when being pressed by the driving mechanism 86 can be suppressed.

Note that the pawl biasing member 64 can be omitted by employing a configuration in which the driving mechanism 86 also presses the coupling portion 82 toward the first position T1 from the second position T2, for example.

The feeding pawl 62 can feed the series of terminals 9 on the stage 111, one terminal 91 after another. Specifically, here, the feeding pawl 62 is coupled to the coupling portion 82. Furthermore, the feeding pawl 62 is provided so as to be able to move back and forth in the feeding direction and the returning direction that is opposite thereto. When moving in the feeding direction, the feeding pawl 62 can be latched at its leading end portion onto a feeding hole 93 of the series of terminals on the stage 111 and feed the series of terminals 9 in the feeding direction.

More specifically, the feeding pawl 62 is provided so as to project from the coupling portion 82 toward the stage 111. Furthermore, the feeding pawl 62 is formed so as to be thinner toward the leading end. A base end portion of the feeding pawl 62 is provided so as to be located within the hole H provided in the workbench S, and linearly moves back and forth within the hole H in the workbench S with the movement of the coupling portion 82 coupled to the moving body portion 66b. A middle portion of the feeding pawl 62 is provided so as to be located within a hole provided in the stage 111, and moves within the hole of the stage 111 with the movement of the coupling portion 82 coupled to the moving body portion 66b. The leading end portion of the feeding pawl 62 is formed so as to project from the stage 111, and is provided so as to be able to enter the feeding holes 93 of the series of terminals 9 placed on the stage 111 The leading end portion of the feeding pawl 62 is latched to one of the feeding holes 93 of the series of terminals 9 when the coupling portion 82 is moved in the feeding direction by the driving mechanism 86, and can move the series of terminals 9 in the feeding direction.

The moving distance restriction portion 70 can restrict the moving distance of the feeding pawl 62. Here, the moving distance restriction portion 70 is formed as a body that is separate from the stage 111 and the like, to which it can be attached and detached with screws or the like. The moving distance restriction portion 70 can thereby be removed, and the moving distance of the feeding pawl 62 can be changed.

That is to say, the moving distance restriction portion 70 can restrict the moving distance of the feeding pawl 62, and is provided in an attachable and detachable manner. Thus, the restriction distance of the removed moving distance restriction portion 70 can be adjusted, or the removed moving distance restriction portion 70 can be replaced with one having a different restriction distance. The distance by which the feeding pawl 62 is moved by the pawl moving mechanism portion 80 can thereby be changed.

Specifically, the moving distance restriction portion 70 includes a body portion 72, and a pair of projecting portions 74 that project from the body portion 72. Furthermore, here, a contacted portion 76 is provided in each projecting portion 74.

Here, the body portion 72 is provided so as to be able to be attached to and detached from the stage 111 with a screw 71 or the like. Furthermore, here, the body portion 72 includes a horizontal-direction guiding portion 73 for restricting the position of the series of terminals 9 on the stage 111 so as not to shift horizontally. The horizontal-direction guiding portion 73 is formed in a thin-plate shape and projects sideward from the body portion 72, and a leading end portion of the horizontal-direction guiding portion 73 bends toward the stage 111. The leading end portion of the horizontal-direction guiding portion 73 is fitted into a groove of the barrel portion 911 of the series of terminals 9. Thus, the series of terminals 9 on the stage 111 does not easily shift horizontally.

Here, the pair of projecting portions 74 is provided so as to be able to be attached to and detached from the body portion 72. The position at which the pair of projecting portions 74 is attached to the body portion 72 is selectable. Specifically, here, the projecting portions 74 is coupled to the body portion 72 with screws 71a or the like. The body portion 72 is provided with a plurality of screw holes 71b that correspond to each screw 71a (here, five screw holes 71b for each projecting portion 74). The position at which each projecting portion 74 is provided in the body portion 72 can be selected by selecting one of the plurality of screw holes 71b. The interval between the pair of projecting portions 74 can be changed by attaching the projecting portions 74 to the body portion 72 at different positions of the screw holes 71b.

Here, although the intervals between the screw holes 71b for each of the pair of projecting portions 74 are set to be the same, this is not essential. The intervals between the screw holes may be different between one projecting portion and the other projecting portion. Thus, the interval of the pair of projecting portions can be selected from more values.

Furthermore, the contacted portion 76 is provided at the leading end of each projecting portion 74. The contacted portion 76 can restrict the movement of the feeding pawl 62 at least either while the feeding pawl 62 is moving from the first position T1 toward the second position T2, or while moving from the second position T2 toward the first position T1.

Specifically, this contacted portion 76 is provided so as to be able to come into contact with the corresponding contact portion 88 of the coupling portion 82 in a state where the moving distance restriction portion 70 is fixed to the stage 111 that is fixed to the workbench S, and the coupling portion 82 is coupled to the moving body portion 66b that moves along the linear movement guiding portion 66a which is fixed to the workbench S. That is to say, each projecting portion 74 projects sideward of the stage 111 from the body portion 72, passes through the hole H of the workbench S, and projects downward of the workbench S, and the contacted portion 76 is provided on the leading end side of the projecting portion 74.

Here, an adjusting screw 76a is provided as each contacted portion 76. The height from each projecting portion 74 to a leading end portion of the adjusting screw 76a can be adjusted by loosening or tightening this adjusting screw 76a. The interval between the pair of contacted portions 76 (adjusting screws 76a) can thereby be adjusted.

The interval (13 in FIG. 9) between the contacted portions 76 can then be adjusted by adjusting the positions of the projecting portions 74 and the degree of the tightening of the adjusting screws 76a. In a state where one of the pair of adjusting screws 76a is in contact with one of the pair of contact portions 88, the interval (I1 in FIG. 6) between the other adjusting screw 76a and the other contact portion 88 is the distance Il by which the coupling portion 82 can move. In other words, the distance obtained by subtracting the interval between the pair of contact portions 88 from the interval I3 between the contacted portions 76 is the distance I1 by which the coupling portion 82 can move. This distance Il by which the coupling portion 82 can move is the moving distance I1 of the feeding pawl 62.

By adjusting this distance I1 by which the coupling portion 82 can move to the interval between two adjacent feeding holes 93 of the series of terminals 9 (the interval on the series of terminals 9, I2 in FIG. 6), the series of terminals 9 can be accurately fed by only one terminal by the terminal feeding mechanism portion 60. Here, since the distance between the pair of contact portions 88 is fixed, the distance (I1 in FIG. 6) by which the coupling portion 82 can move can be adjusted by adjusting the interval (I3 in FIG. 9) of the contacted portions 76.

However, although the distance between the pair of contact portions 88 may also be adjustable, it is easier to adjust the distance I1 by which the coupling portion 82 can move if the distance between the pair of contact portions 88 is fixed.

To adjust the interval between the contact portions 76 of the moving distance restriction portion 70 in accordance with the type of the series of terminals 9, two methods are available, namely a method of replacing the moving distance restriction portion 70 and a method of adjusting the removed moving distance restriction portion.

That is to say, in the case of replacing the moving distance restriction portion 70, a plurality of moving distance restriction portions 70 having different intervals between the contacted portions 76 are prepared in advance in accordance with the types of the series of terminals 9, and when the series of terminals 9 is replaced, the moving distance restriction portion 70 is also replaced with one that is suitable for the replaced series of terminals 9. In this case, the time or the like for adjusting the moving distance restriction portion 70 can be suppressed.

In the case of adjusting the removed moving distance restriction portion, when replacing the series of terminals 9, the positions of the projecting portions 74 and the height of the adjusting screws 76a of the removed moving distance restriction portion 70 are adjusted, and the moving distance restriction portion 70 is again attached after this adjustment. In this case, costs or the like of members of the moving distance restriction portion 70 can be suppressed.

Note that the number of attachable and detachable projecting portions 74 may not be two, but may also be only one. Similarly, the number of adjusting screws 76a may not be two, but may also be only one. In this case as well, the interval I3 between the contact portions can be adjusted by adjusting at least one of the position of the projecting portions and the height of the adjusting screws.

It is not essential that the distance that can be restricted by the moving distance restriction portion 70 is adjustable due to the pair of projecting portions 74 being attachable to and detachable from the body portion 72 and the adjusting screws 76a being provided. That is to say, one moving distance restriction portion 70 may be able to restrict only one distance. In this case, the moving distance of the feeding pawl 62 can be adjusted to the interval between two adjacent feeding holes 93 of the series of terminals 9 by preparing in advance a plurality of moving distance restriction portions 70 having different restriction distances.

### Operations

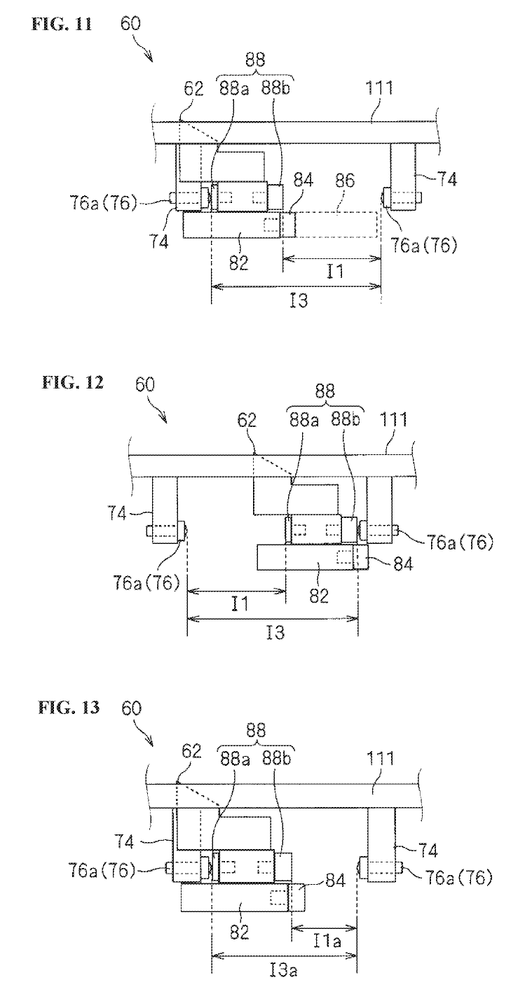

Next, a restricting operation of the moving distance restriction portion 70 at the time when the feeding pawl 62 moves will be described. FIGS. 11 and 12 are illustrative diagrams showing a part of the terminal feeding mechanism portion 60. In FIG. 11, the coupling portion 82 comes into contact with the moving distance restriction portion 70 in the feeding direction. In FIG. 12, the coupling portion 82 comes into contact with the moving distance restriction portion 70 in the returning direction.

The coupling portion 82 with which the feeding pawl 62 is continuous moves in the feeding direction against the biasing force of the pawl biasing member 64 by being pressed by the driving mechanism 86. The coupling portion 82 that has been moved in the feeding direction stops by the feeding-direction contact portion 88a thereof coming into contact with the contacted portion 76 of the projecting portion 74 located in the feeding direction, as shown in FIG. 11.

As a result of the feeding pawl 62 whose leading end portion latches to a feeding hole 93 of the series of terminals 9 moving simultaneously with the coupling portion 82, the series of terminals 9 is moved in the feeding direction by the moving distance of the coupling portion 82. Here, the series of terminals 9 can accurately move by only one terminal by attaching the moving distance restriction portion 70 in which the moving distance of the coupling portion 82 is adjusted in advance to the interval between two adjacent feeding holes 93 of the series of terminals 9.

Note that, here, in the case where the driving mechanism 86 presses the feeding pawl 62, and the feeding pawl 62 comes into contact with the moving distance restriction portion 70 and stops, a command to stop the driving mechanism 86 is given from the control portion 140 if a load applied by the driving mechanism 86 has become excessively large.

After the coupling portion 82 moves in the feeding direction and stops, if the pressing by the driving mechanism 86 is cancelled, the coupling portion 82 is moved in the returning direction by the biasing force of the guiding and biasing member 56. Then, the coupling portion 82 that has been moved in the returning direction stops as a result of the returning-direction contact portion 88b coming into contact with the contacted portion 76 of the projecting portion 74 located in the returning direction. Meanwhile, the driving mechanism 86 such as an air cylinder is also restored again to a state in which it is able to press the coupling portion 82. Then, the driving mechanism 86 again begins to press the coupling portion 82 in the feeding direction.

Subsequently, an operation of accurately feeding the series of terminals 9 by only one terminal can be repeated by repeating the above-described operation.

### Adjustment of Moving Distance I1 of Feeding Pawl 62.

Next, an operation of adjusting the moving distance I1 of the feeding pawl 62 will be described.

FIG. 13 is an diagram showing a part of the terminal feeding mechanism portion 60. In FIG. 13, the positions of the projecting portions 74 have been changed such that the interval I3a between the contacted portions 76 is different from the interval I3 between the contacted portions 76 in FIG. 11.

Specifically, the positions of the projecting portions 74 are changed such that at least one of the projecting portions 74 is fixed with a screw further inward than in the state shown in FIG. 11, in a state where the moving distance restriction portion 70 has been removed. Thus, the interval I3a between the contacted portions 76 is smaller than in the state shown in FIG. 11. The moving distance I1a of the feeding pawl 62 is also thereby smaller than in the state shown in FIG. 11.

To increase the interval I3 between the contact portions 76, the positions of the projecting portions 74 are changed such that at least one of the projecting portions 74 is fixed with a screw further outward in a state where the moving distance restriction portion 70 has been removed. The interval I3 between the contacted portions 76 can thereby be increased. The moving distance I1 of the feeding pawl 62 can also thereby be increased.

Note that, in the case of changing the interval I3 between the contacted portions 76, either one of the adjustment of the adjusting screws 76a and the change of the positions of the projecting portions 74 may be performed, or both may be performed. In the case of adjusting the adjusting screws 76a, only one of the adjusting screws 76a may be adjusted. Similarly, in the case of changing the interval between the projecting portions 74, the position of only one of the projecting portions 74 may be changed.

The interval I3 between the contacted portions 76 can be changed by performing at least one of the adjustment of the adjusting screws 76a and the change of the interval between the projecting portions 74. Thus, if the type of the series of terminals 9 is changed and the interval I2 between two adjacent feeding holes 93 changes, the moving distance I1 of the feeding pawl 62 can be adjusted to the interval I2 between the feeding holes 93.

### Effects

With the terminal feeding device 110 according to the embodiment, the moving distance restriction portion 70 is provided in an attachable and detachable manner. The distance by which the feeding pawl 62 is moved by the pawl moving mechanism portion 80 can be changed by adjusting the restriction distance of the moving distance restriction portion 70 or replacing the moving distance restriction portion 70 with one having a different restriction distance. Accordingly, multiple types of terminals can be flexibly dealt with.

Furthermore, due to the provision of the terminal guiding mechanism portion 54 provided so as to be able to guide at least a part of the series of terminals 9 wound around the terminal reel R until reaching the stage 111, and the guiding and biasing member 56 capable of biasing the terminal guiding mechanism portion 54, the series of terminals 9 can be dealt with regardless of the winding manner in which the series of terminals 9 is wound around the terminal reel R. Thereby, multiple types of terminals can be flexibly dealt with.

Although this invention has been described in detail as above, the above description is an example in all aspects, and this invention is not limited thereto. It would be understood that a number of modifications that have not been described as examples can be assumed without departing from the scope of this invention.

### LIST OF REFERENCE NUMERALS

9 Series of terminals
90 Terminal with band pieces
91 Terminal
911 Barrel portion
912 Ter minal connecting portion
92 Chain band
921 Band piece
25 Terminal crimping system
110 Terminal feeding device
111 Stage
50 Terminal supply portion
52 Reel supporting portion
54 Terminal guiding mechanism portion
54a Shaft portion
54b Arm portion
55 Guiding portion
56 Guiding and biasing member
60 Terminal feeding mechanism portion
62 Feeding pawl
64 Pawl biasing member
66 Support mechanism portion
70 Moving distance restriction portion
76 Contacted portion
80 Pawl moving mechanism portion
86 Driving mechanism
T1 First position
T2 Second position
I1, I1a Moving distance of feeding pawl
I2 Interval between feeding holes of series of terminals
I3, I3a Interval between contacted portions

1. A terminal feeding device for feeding a series of terminals in which a plurality of terminals are continuously arranged, one terminal after another, comprising:
a stage on which the series of terminals can be placed;
a feeding pawl configured to move back and forth in a feeding direction and a returning direction that is opposite to the feeding direction, the feeding pawl latching, when moving in the feeding direction, with its leading end portion to a feeding hole of the series of terminals on the stage, and feeding the series of terminals in the feeding direction;
a pawl moving mechanism configured to move the feeding pawl back and forth; and
a moving distance restrictor configured to restrict a distance by which the feeding pawl is moved by the pawl moving mechanism,
wherein the moving distance restrictor is attachable and detachable, a restriction distance of the moving distance restrictor that has been removed being adjustable, or the moving distance restrictor that has been removed being replaceable with a moving distance restrictor having a different restriction distance, such that the distance by which the feeding pawl is moved by the pawl moving mechanism can be changed.

2. The terminal feeding device according to claim 1, further comprising:
a support mechanism configured to support the pawl moving mechanism so as to be able to move back and forth between a first position and a second position; and
a pawl biasing member configured to bias the feeding pawl toward the first position,
wherein the pawl moving mechanism pushes the feeding pawl from the first position to the second position, and
the moving distance restrictor includes a contacted portion that restricts the movement of the feeding pawl while the feeding pawl is moving from the first position to the second position and/or while the feeding pawl is moving from the second position to the first position.

3. The terminal feeding device according to claim 1, further comprising:
a reel supporter that rotatably supports a terminal reel around which the series of terminals is wound;
a terminal guiding mechanism including a shaft that is rotatable, an arm extending from the shaft, and a guiding portion provided at a leading end of the arm, the terminal guiding mechanism being configured to guide at least a part of the series of terminals wound around the terminal reel to the stage; and
a guiding and biasing member configured to bias the terminal guiding mechanism,
wherein the terminal guiding mechanism changes a posture thereof or rotates in accordance with a direction in which the series of terminals is supplied from the terminal reel.
